(19) United States
(12) Patent Application Publication
(10) Pub. No.: US 2003/0151622 A1
(43) Pub. Date: Aug. 14, 2003

(54) Method and apparatus for automated transaction processing

(76) Inventors: Henry Wolfond, Toronto (CA); Gord MacLeod, Toronto (CA)

Correspondence Address: Fasken Martineau DuMoulin LLP, Toronto Dominion Bank Tower, Toronto-Dominion Centre, Box 20, Suite 4200, Toronto, ON, M5K 1N6, CA

(21) Appl. No.: 10/303,077

(22) Filed: Nov. 25, 2002

Related U.S. Application Data
(63) Continuation of application No. 09/441,456, filed on Nov. 17, 1999, now abandoned.

(51) Int. Cl. G09G 5/00

(52) U.S. Cl. 345/745

(57) ABSTRACT

A form and information integration system includes individual systems and a network connecting the individual systems. The systems include a first system, a central system, and a second system. A plurality of information located on the integration system is obtainable by the first system and the information is related to a plurality of forms. Selected elements of the information obtained by the first system are used to pre-populate the forms. A common language facilitates the transfers of the selected elements of the information between the individual systems. A navigation bar with common elements associates with the individual systems is associated with the information obtainable by the first system.

This application is a Continuation Application from U.S. application Ser. No. 09/441,456, filed Nov. 17, 1999.

The present invention relates to an internet based automated processing systems and more particularly to an automated trade processing system which interfaces a customers own portfolio management, quoting, analytical and alerting services to transaction execution systems.

### BACKGROUND OF THE INVENTION

The increased popularity of the Internet and the development of the World Wide Web (WWW) have resulted in an increase in Internet commerce or on-line commerce. On-line commerce involves the exchange of goods, services, and information as a result of transactions executed using an on-line computer system. On-line commerce is often achieved using a computer application and system that allows access to information from disparate data sources through the Internet.

On-line commerce computer applications and systems are difficult to design and implement, frequently taking years to develop. In particular, the development of computer applications and systems requiring interprocess communication for access to disparate data sources is complex and time consuming. Disparate data sources include information or data from such sources as databases, application programs, or systems that reside on multiple and disparate platforms, database management systems, and environments that may be physically separated from one another.

One of the difficulties and complexities arise from the interface software that must be developed for each disparate data source to ensure that information can be accessed from each disparate data source in a timely and accurate manner. The interface software is difficult and complex to develop because each disparate data source may have a different or proprietary method and format or protocol for exchanging data.

From a user or customers point of view there is a considerable relearning of the format of the interfaces, although common data may be used.

Time sensitive data is any data that frequently changes. For example, on-line commerce computer applications and systems involving the trading of securities, such as stocks, bonds, notes, options, fixtures, mutual funds, and the like, rely heavily on time sensitive data to ensure that trades are timely placed and that decisions are based on accurate and up-to-date information.

Online stock transactions have been made much simpler With the advent of the Internet. For example individuals may directly trade a specific security such as stocks, bonds, notes, options, futures, mutual funds, and the like by signing up with a particular online brokerage firm. In order to research these securities the individual typically can access a variety of information sources or web sites in order to obtain relevant background and purchase information about the security. The information may be collated and organized to set up a portfolio.

At the relevant time when the individual decides to initiate a transaction, the individual must contact a broker to execute the trade on selected securities in the portfolio. Normally if the broker is an online system the individual or the broker must manually fill in the corresponding data fields of a purchase order from the listed information. The individual often has already recorded this information when researching the portfolio, but now has to rerecord the information for the broker. This is wasteful of time and prone to errors or may require the individual to repeat part of the information research to gather missing information required by the broker.

Brokerage firms also tend not to offer consistent user interfaces or data entry forms, further exacerbating the above problem. More generally a problem with independent systems that wish to share a set of common information over the network, is that sometimes the common information is labeled or identified differently by each independent system. An example of this is where a brokerage and a secondary party employ a different set of symbols for the same stock and mutual funds on their respective web sites. The potential problems in this situation are the caused by differences in the format or language of the information stored, the form in which it is transmitted, and identification and separation of a subset of specific from a general information set.

In the compilation of valuable or restricted information, a person typically is a registered user in each of a variety of separate databases. If a set of restricted information desired by the person is located in a number of the databases or web sites, the person must login and logout of each site separately. For extensive research purposes, separate restricted web sites are not all linked together. The disadvantage of this is that time must be spent in navigating between the different sites and effort expended in keeping track of where each of the different sites are located.

Thus there is a need for a system and method that seamlessly facilitates exchange and collation of information between separate systems on a network and which reduces the need to reenter portions of data common to the systems.

### SUMMARY OF THE INVENTION

In accordance with the present invention there is provided a system for seamless communication of data between two or more systems comprising:

(a) a subscriber system for presenting and displaying data from one or more information sources to a subscriber in a predetermined subscriber format; and

(b) a remote system couplable by a network to the subscriber system, the subscriber system responsive to information received in addition to said subscriber format data for providing a service to said subscriber, whereby the additional information is based on a priori knowledge of said subscriber system and remote system data formats.

Another aspect of the invention provides a method for translating and transferring data from a source format to a destination format using a priori knowledge of said source and destination formats between a remote system and a subscriber system, said method comprising the steps of:

(a) a subscriber composing a list of data according to the source format;

(b) transmitting, by said subscriber system, a particular subscriber source data file to said remote system via a communications network;

(c) transmitting format translation data to the remote system,

(d) parsing the subscriber source data and the translation data at the remote system for reformatting the subscriber data into the destination format data.

In accordance with a further aspect of the invention there is provided a method of pre-populating a form including the steps of a gathering of information from a plurality of sources, (b) compiling the information from at least one of the information sources on a central system, (c) transferring selected elements of the information from the central system to a secondary system, and (d) entering automatically the selected elements in a plurality of corresponding data fields in a form at the secondary system.

In a still further aspect of the invention the integration system comprises a common language to facilitate the transfer of the selected elements of the information between the individual systems.

### BRIEF DESCRIPTION OF THE DRAWINGS

These and other features of the preferred embodiments of the invention will become more apparent in the following detailed description in which reference is made to the appended drawings wherein:

FIG. 1 is a schematic diagram of a network configuration for an online transaction processing system;

FIG. 2 is an example of product information for a financial application of FIG. 1;

FIG. 3 is an example of product information for a financial application of FIG. 1.

FIG. 4 is an example of product information for a financial application of FIG. 1.

FIG. 5 is an example of an order entry form pertaining to FIG. 2.

FIG. 6 is an example of a login screen for the system of FIG. 1.

FIG. 7 is a schematic of the operation of the integration system of FIG. 1.

FIG. 8 provides additional features of FIG. 7.

FIG. 9 is a further embodiment of FIG. 1.

FIG. 10 is a further embodiment of FIG. 1.

### DESCRIPTION OF THE PREFERRED EMBODIMENTS

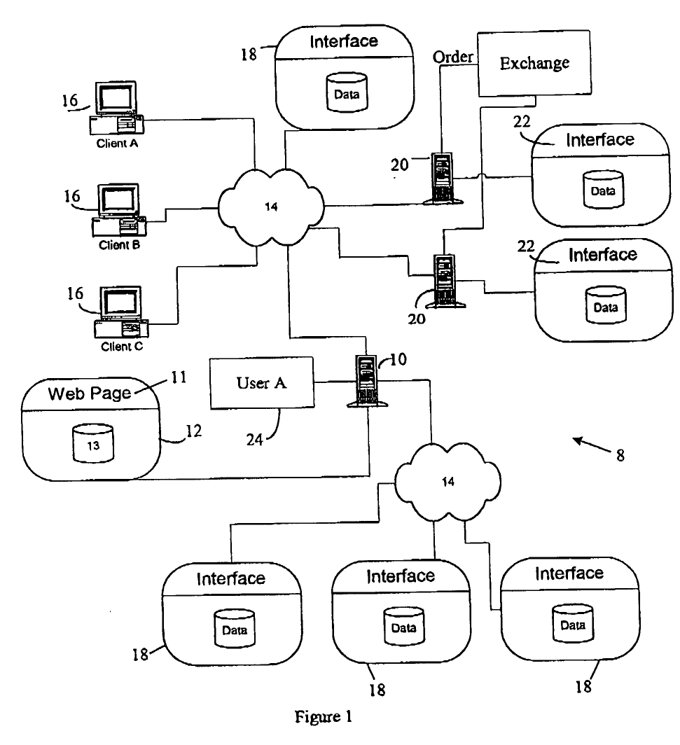

In the following description like numerals refer to like structures in the drawings. Furthermore in the following description an online portfolio management and brokerage system is used to exemplify the method and system features of the present invention. Referring to FIG. 1, components of an online transaction system is shown generally by numeral 8. The system includes a web server 10, generally hosting a central web site 12 for providing a plurality of subscriber web pages. A plurality of client computers 16 may connect to the web site 10 via the Internet 14 for viewing general web pages and subscriber web pages 11 hosted at the web site 12 using web browsers or the like, The web site 12 includes a database 13 for maintaining amongst others user/subscriber account information. A series of information sources 20, such as stock quote and find analyzer providers, are connected either directly 19 to the central website 10 or via the Internet 14 which may be accessed by the client to obtain research on a particular product or service. In addition a series of product or specialized service providers 20, such as brokerage web sites are also connected to the central web site 10 directly or via the Internet 14. The product providers 20 may have products the client 16 wishes to obtain or purchase. In particular if the product providers are brokerage web sites, they may be connected to an appropriate exchange 24. The product providers also referred to as the remote system includes a database for maintaining client records and access information. The product providers 20 each have a set of unique web pages 22 for providing logon, client verification, order entry, order acknowledgement and such like.

The system facilitates clients or users 16 to purchase a particular service or product—securities in this embodiment. Generally research must be performed on a particular stock by accessing one or more of the information sources 20. Each of theses information sources normally requires a separate logon verification and authentication of the user before providing research information to the user. The research information is then collated or assembled at a central location 10 to construct a personalized or customized stock portfolio for the client 16. A stock purchase or sale is then made by the client 16 accessing a selected broker web site 20 to place an order. This also requires the entry of logon information, stock data and such like.

The present invention is derived from the recognition that in a typical scenario as described above, data, which is common to all locations, is entered by a user separately in each location, and requires connection, by the user to each location.

Accordingly the present invention provides a method for translating and transferring data from a source format at the subscriber site to a destination format at the provider site using a priori knowledge of the source and destination. The method comprises the steps of composing a list of data in the source format and storing it in the database 13 in a source data file at the subscriber system 10, initiating a transaction by the subscriber to a selected provider, transmitting subscriber source data file to the remote provider system 20 via the Internet including transmitting format translation data to the remote system; parsing the subscriber source data and the translation data at the remote system for reformatting the subscriber data into the destination format data and executing the transaction by the provider whereby data common to the system need not be reentered.

In one embodiment the subscriber system 10 installs a translation module at the provider site 20. An interactive session between each of the clients 16 and selected information sources 12 and product providers 20 is managed by the central website 10, once the client 16 has logged onto the central website 10. Specific product information 24 gathered by for example the client A 16 while on the central website 10, from the various connected information sources 20, is sent by the central website 10 in the form of a “decorated URL” to product providers 20 selected by the client 16. The specific product information is used to dynamically fill in, or pre-populate, data fields in a form located on a website of the product provider 20.

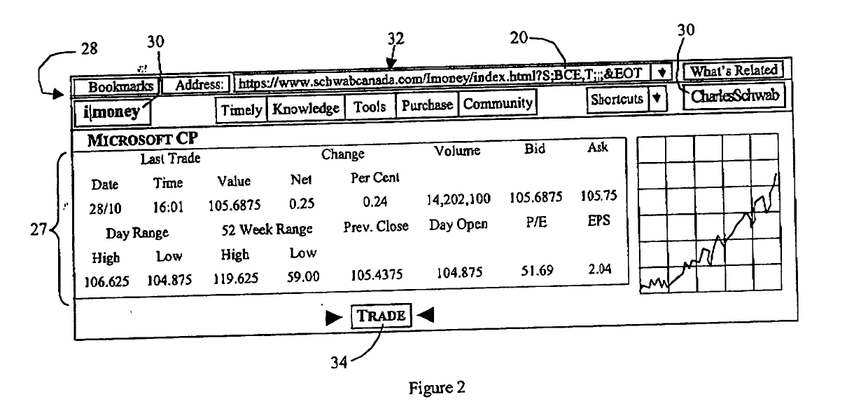

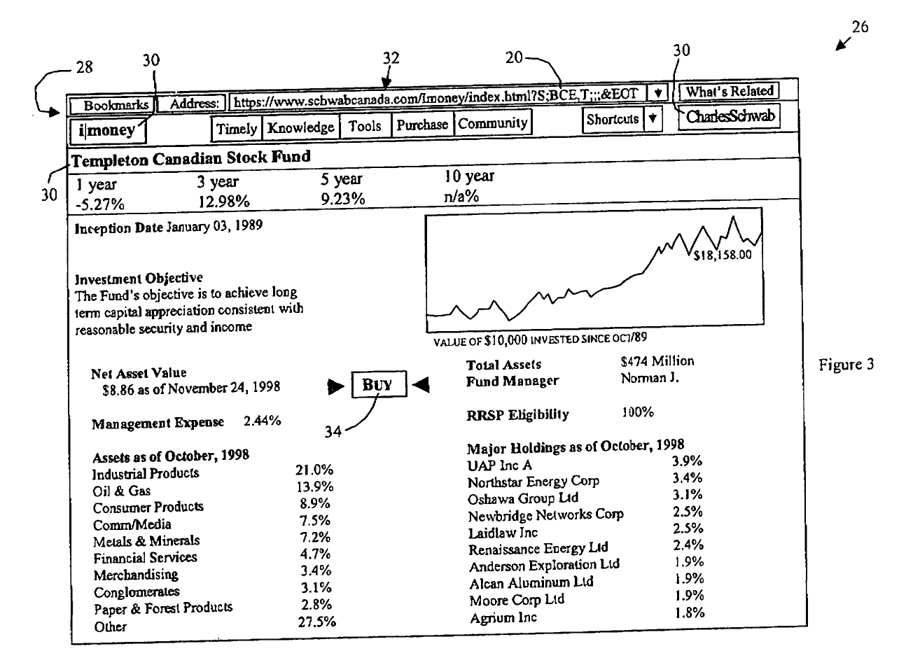

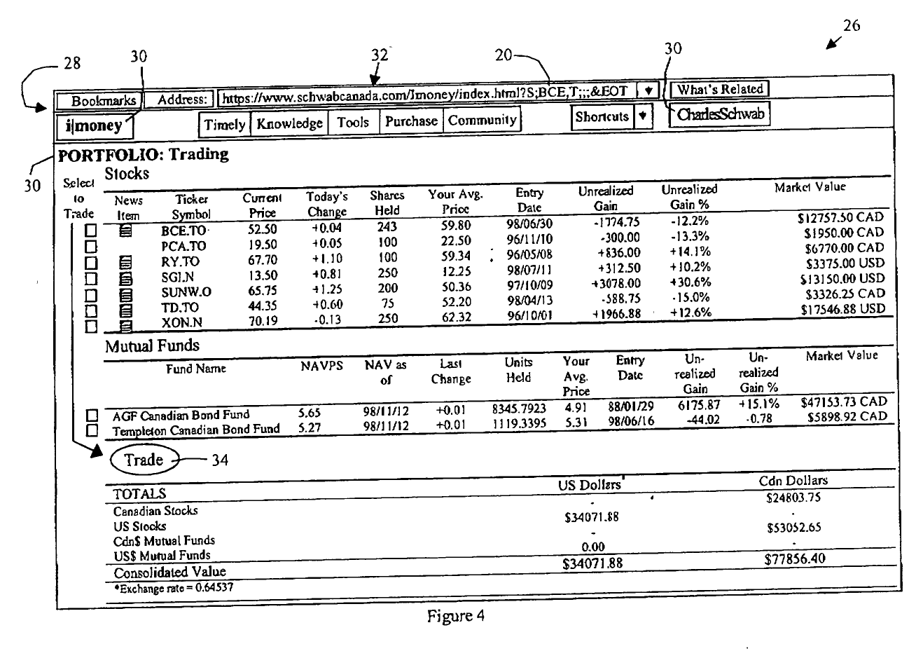

Referring to FIGS. 2, 3, and 4 sample screens illustrating the format and data fields provided by one or more of the information sources 20 for a financial planning system is shown. In FIG. 2, web page 26 displays data 27 comprised of stock quote information, stock fund information, and portfolio information. The client computer 16 through the central web site 10 accesses the data 27. A co-branded navigation bar 28 is displayed on the web page which provides links to one or more web pages for which data is being displayed. These links 30 are preferably hypertext links which provide a “seamless” feature to the online transaction system 8, as the client 16 transfers the specific information 20 from one web page to another. The specific information 20 is preferably transferred between web pages in the form of embedded arguments in a decorated URL 32. In the case of a stock purchase, the information 20 includes all the relevant purchase information compiled by the client 16 on the central website 10, such as the name of a stock, stock prices, number of desired stocks, as well as any information required to identify the client 16.

The client 16 can preview as many information sources 12 as desired which are connected to the central website 10. For specific information 20 of interest encountered by the client 16 during the course of the information search, the client 16 can click on a purchase button 34 at any time. The purchase button 34 is a direct link to the webpage of a product provider 20 selected by the client 16.

The purchase button 34 effects a transfer of the specific information 20 in the form of information variables to a query string such as:

?S/F; symbol; B/S/U; Qty; $/U&EOT,

attached to the URL 32 of the provider, assuming a hypertext transfer protocol. Descriptions of the types of variables 36 contained in the query string are given in the Table below:

| Variables | Description |
|---|---|
| S/F | this indicates stock or fund |
| Symbol | this represents the commodity symbol |
| B/S/N | buy, sell or unknown |
| Qty | the quantity entered or a null value |
| $/U/N | indicates whether trade is being executed in |
| | dollars or units or is unknown |
| & | signifies the end of a specific symbol string |
| EOT | Signifies the end of the trade order. |

The above-mentioned URL syntax is given for a financial application by way of example only. Other variables may be used which depend on the particular application and transfer protocol being used.

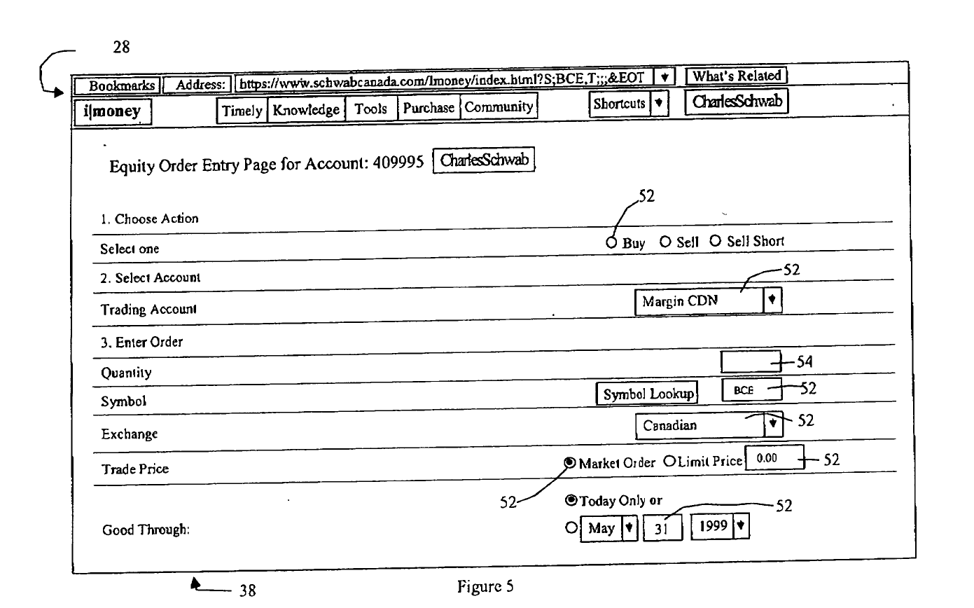

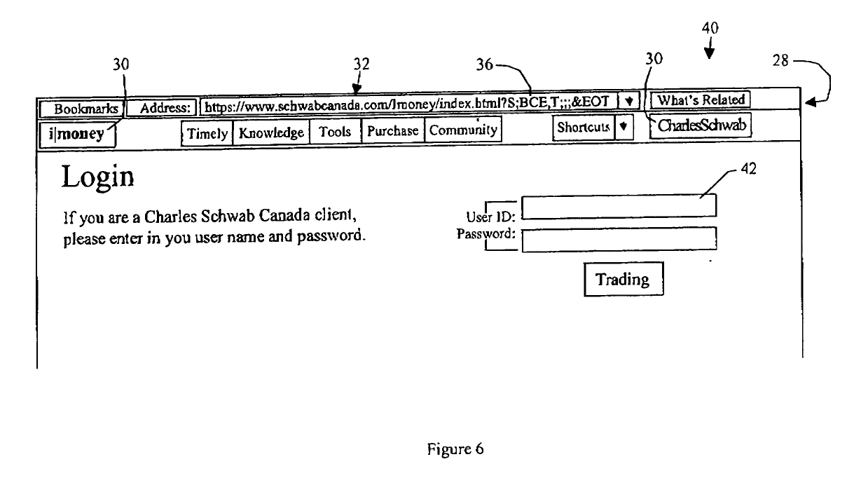

Referring to FIG. 5, an example of a pre-populated order entry form 38 as contained on the web page of a product provider 20 is shown generally by numeral 38. In this example, the translation variables transferred are the symbol BCE and a buy command B. In the preferred embodiment, this screen 38 would only be accessible to the client 16 after the completion of an intermediate login screen 40, as shown in FIG. 6. The screen 40 includes the cobranded navigation bar 28, the decorated URL 32 with the transfer variables 38, as well as security data fields 42 used to identify the client 16 to the product provider 20. This screen 40 allows for security authorization for the purchase transaction.

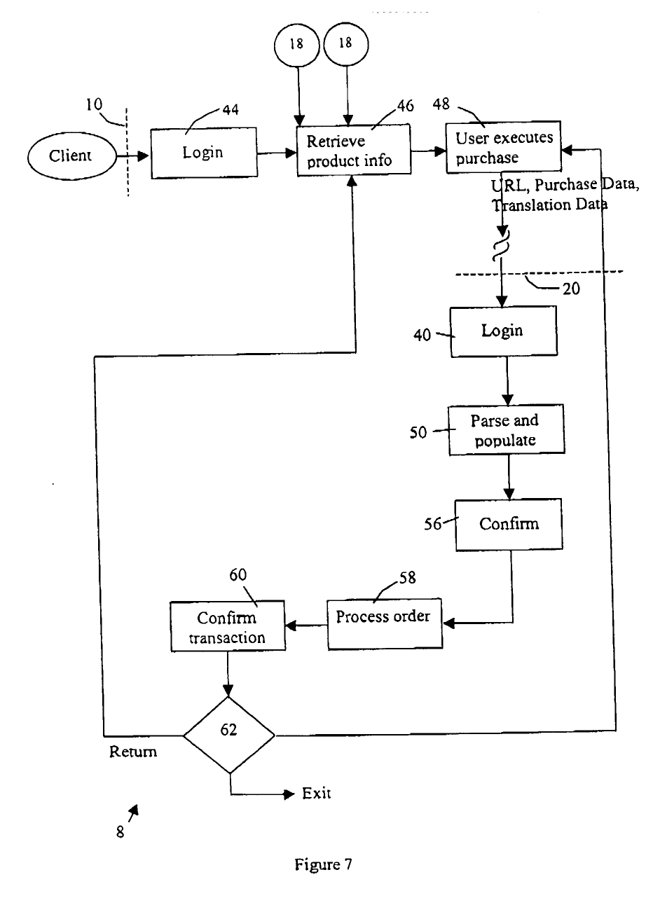

The operation of the system 8 is illustrated schematically by referring to FIG. 7. A registered client 16 completes a login process 44 to obtain access to the central website 10. The client 16 then proceeds to compile product information 46 from the variety of information sources 20, which can be accessed from the central web site 10. Once the client 16 has obtained sufficient information the client then may proceed to a purchase fulfillment stage 48, the client 16 clicks on the purchase button 34 located on the web pages 26. The central website 10 transmits the specific information 20 containing the variables 36 in the form of the decorated URL 32 to the login screen 40 of the product provider 20.

The client 16 selects a desired one of the product providers 20 and supplies the security data 42 which authorizes the client 16 to conduct transactions on the website of the selected product provider 20. At stage 50, the provider parses the received information 20 to populate data fields 52 on the trading screen 38. These fields are then pre-populated with the specific information 20 from the decorated URL 32. Additional data fields 54 may be manually filled in by the client 16 or by agents of the product provider 20, if required.

At the next stage 56, the client 16 confirm the information contained in the data fields 52 and 54 and may confirm the transaction with a transaction password, if desired. The purchase transaction is processed 58 by the product provider 20 and the provider 20 sends a confirmation message 60 to the client 16 upon completion of the transaction. At a decision stage 62, the client 16 can proceed to other website areas of the product provider 20, or return to the central website 10 to conduct further product research. These transfers between websites is facilitated by the links 30 on the co-navigation bar 28.

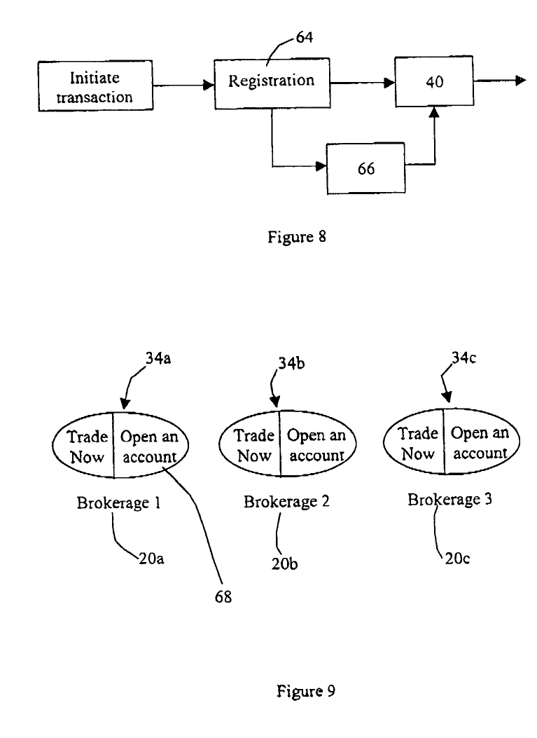

Referring to FIG. 8, a variation of the process flow is shown with an unregistered client 16. In this process flow the client is presented with an intermediate registration screen 64. A brokerage sign up kit 66, may also be presented to the client 16 by the central website 10 on behalf of the product provider 20. Once the registration process is complete, the client 16 can then proceed seamlessly to the login screen 40 of FIG. 7 and proceed with the rest of the transaction procedure, as described above.

In an alternative embodiment, a series of purchase buttons 34ab,c, as shown in FIG. 9, are provided on the web pages of the information sources 12 in place of the single button 34. These buttons 34ab,c provide the client 16 with a choice as to which product provider 20a,b,c the client 16 desires to process the purchase transaction request. A registration toggle 68 may be included in the purchase button 34a,b,c if desired, which would automatically supply the client 16 with the sign up kit 66 on behalf of the product provider 20.

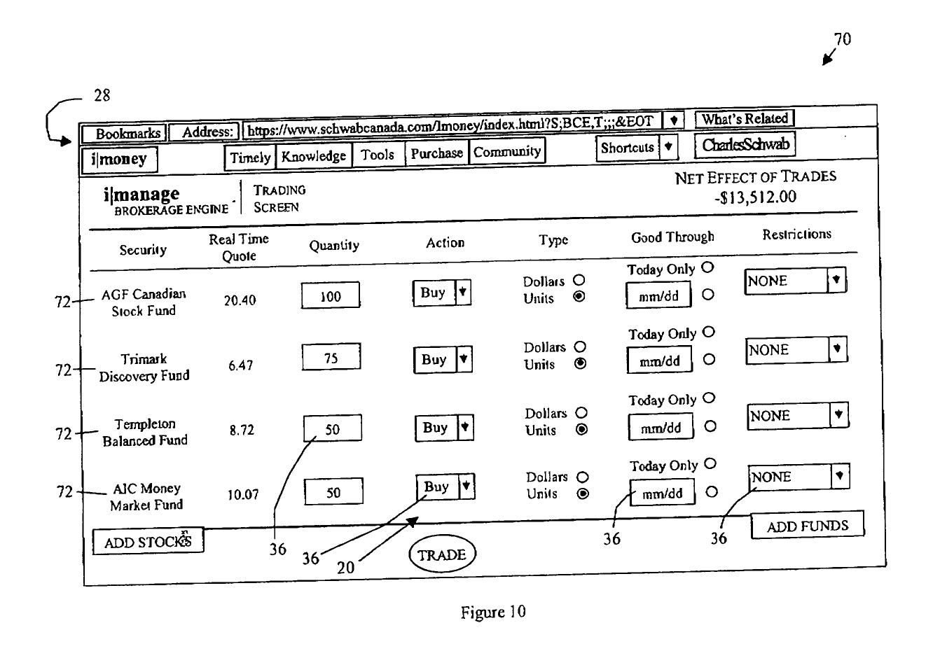

In a further embodiment shown in FIG. 10, instead of directly going to an order entry form 38 upon clicking the purchase button 34, the client can choose to use a trading basket 70. Each time the client 16 decides on a purchase, the purchase button 34 initiates a transfer of the variables 36 used for a purchase transaction to the trading basket 70. A plurality of individual transactions 72 are stored in the basket 70, until a basket purchase button 74 is clicked by the client 16. At this stage, the decorated URL 32 passes the trade variables 36 of the specific information 20 to the login screen 40 of the FIG. 7. The client 16 then proceeds with the remainder of the transaction procedure, as described above.

A still further embodiment of the invention, a variable translation system 76 is used when the product provider 20 and the central website 10 employ a different set of identifiers for the variables 36, such as stock symbols and mutual funds. In the preferred embodiment, the brokerage integration system 8 is implemented on the client side over the Internet using any one of the known browsers. The operating systems supported are Windows 3.1 and above, Mac 7.6 and above, Windows NT 4.0 and above, and Windows 95 and above. The central website 10 employs servers consisting of two Ultra 2 work stations with two 300 MHz processors and 2 GB RAM. Also employed is an Orade E 3500 with four 300 MHz processors and 8 GB of RAM. The system of the product provider 20 operates in a CGI environment with Perl 5 deployed and supported. The CGI is compatible with the form of the decorated URL 32 supplied by the central website 10.

In addition to computers connected to the network 14, other communication devices such as mobile phones, hand held devices, personal digital assistants and set top boxes can also be used.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A system for seamless communication of data between two or more systems comprising:
(a) a subscriber system for presenting and displaying data from one or more information sources to a subscriber in a predetermined subscriber format; and
(b) a remote system couplable by a network to the subscriber system, the subscriber system responsive to information received in addition to said subscriber format data for providing a service to said subscriber, whereby the additional information is based on a priori knowledge of said subscriber system and remote system data formats.

2. A method for translating and transferring data from a source format to a destination format using a priori knowledge of said source and destination formats between a remote system and a subscriber system, said method comprising the steps of:
(a) a subscriber composing a list of data according to the source format;
(b) transmitting, by said subscriber system, a particular subscriber source data file to said remote system via a communications network;
(c) transmitting format translation data to the remote system;
(d) parsing the subscriber source data and the translation data at the remote system for reformatting the subscriber data into the destination format data.

3. A form and information integration system comprising:
(a) a plurality of information sources coupled by a network, each information source representing an individual system;
(b) said individual systems including a first system, a central system, and a second system;
(c) a plurality of information located on said integration system obtainable by said first system, and a plurality of forms, wherein selected elements of said information obtained by said first system are used to pre-populate said forms.

4. A form and information integration system of claim 3, wherein said network is the internet and said individual systems employ a plurality of web pages each on a web site associated with said individual systems.

5. A form and information integration system according to claim 4 further comprising an navigation bar associated with said information, wherein said navigation bar has common elements associated with at least two of said individual systems.

6. A form and information integration system according to claim 3, wherein a plurality of data fields of said forms are filled in dynamically on at least one of said individual systems by said selected elements.

7. A form and information integration system according to claim 3 further comprising a common language to facilitate the transfer of said selected elements of said information between said individual systems.

8. A form and information integration system according to claim 5, wherein said common elements are a plurality of links connecting one of said individual systems to at least one another of said individual systems.

9. A form and information integration system according to claim 4 further comprising a transaction button associated with said information.

10. A form and information integration system according to claim 9, wherein said transaction button initiates an exchange of said selected elements of said information between at least two of said individual systems.

11. A form and information integration system according to claim 3, wherein said forms are purchase forms.

12. A form and information integration system according to claim 11, wherein said purchase forms are employed to purchase a product associated with said information.

13. A form and information integration system of claim 3, wherein said network is an intranet.

14. A form and information integration system according to claim 4, wherein said select, elements are transferred as embedded arguments in a URL.

15. A method of pre-populating a form with a plurality of information including the steps of: gathering of said information from a plurality of information sources, compiling of said information from at least one of said information sources on a central system, transferring of selected elements of said information from said central system to a secondary system, and entering dynamically of said selected elements in a plurality of corresponding data fields on said form.

16. A method of pre-populating according to claim 15, wherein said data fields are in at least one form shared by said central system and said secondary system.

17. A method of pre-populating according to claim 16, wherein said form is a purchase form.

18. A method of pre-populating according to claim 15, wherein said selected elements are transferred as embedded arguments in a URL.
